(19) United States
(12) Patent Application Publication
(10) Pub. No.: US 2011/0244076 A1
(43) Pub. Date: Oct. 6, 2011

(54) CARBONATED DAIRY NUTRIENT BEVERAGE AND METHOD OF MAKING A CARBONATED DAIRY NUTRIENT BEVERAGE TO SUPPLY THE SAME NUTRITION OF SKIM MILK IN THE HUMAN DIET

(76) Inventors: George H. Clark, Woburn, MA (US); Mary Ann Clark, Woburn, MA (US)

(21) Appl. No.: 13/079,851

(22) Filed: Apr. 5, 2011

Related U.S. Application Data
(63) Continuation-in-part of application No. 11/080,897, filed on Mar. 15, 2005, now Pat. No. 7,493,413.
Application No. 11/080,897 is a continuation-in-part of application No. 10/352,011, filed on Jan. 27, 2003, now Pat. No. 6,866,877.
Application No. 10/352,011 is a continuation-in-part of application No. 10/004,149, filed on Oct. 31, 2001, now Pat. No. 6,835,402.
Application No. 10/004,149 is a continuation-in-part of application No. 09/473,252, filed on Dec. 27, 1999, now Pat. No. 6,403,129.
Application No. 09/473,252 is a continuation-in-part of application No. 11/810,092, filed on Jun. 4, 2007, now abandoned.
(60) Provisional application No. 60/114,096, filed on Dec. 29, 1998.

(51) Int. Cl. A23C 9/152; A23C 9/156; A23C 9/158; A23C 9/12; A23C 7/04

(52) U.S. Cl. 426/42; 426/584; 426/548; 426/73; 426/72; 426/61

(57) ABSTRACT

Carbonated dairy nutrient beverage solutions that supply essential nutrients in the human diet are disclosed. The solutions may contain per 8 oz., calcium, magnesium and potassium ions in the form of salts, vitamins A, D, C, and optionally lutein, zeaxanthin and folic acid in specified amounts to provide dietary supplementation. Sweeteners, stabilizers and flavors can also be added to enhance flavor, sensory appeal, mouth-feel, ingredient solubilization and product appearance. A method of making the beverages is also described. A method of using Carbon Dioxide and Nitrogen to reduce bacterial counts and reduce degradation of essential nutrients in dairy beverages with or without pasteurization is also disclosed.

### CROSS-REFERENCE TO RELATED APPLICATIONS

This is a continuation-in-part of pending U.S. application Ser. No. 11/080,897, filed Mar. 14, 2005, which is a continuation-in-part of U.S. application Ser. No. 10/352,011, filed Jan. 27, 2003, now U.S. Pat. No. 6,866,877, issued Mar. 15, 2005, which is a continuation-in-part of U.S. application Ser. No. 10/004,149, filed Oct. 31, 2001, now U.S. Pat. No. 6,835,402, issued Dec. 28, 2004, which is a continuation-in-part of U.S. application Ser. No. 09/473,252, filed Dec. 27, 1999, now U.S. Pat. No. 6,403,129, issued Jun. 11, 2002, which claimed the benefit of U.S. Provisional Application No. 60/114,096, filed Dec. 29, 1998. This is also a continuation-in-part of pending U.S. application Ser. No. 11/810,092, filed Jun. 4, 2007. The contents of each identified prior application are incorporated in their entirety herein by reference.

### FIELD OF THE INVENTION

This disclosure relates to supplemented carbonated dairy nutrient beverages for the supplementation of essential nutrients in the human diet. This invention further relates to a method for producing carbonated dairy nutrient beverages that suppresses the growth of bacterial cultures, and thereby extends product shelf life and increases the sensory appeal of dairy products to populations who do not like or drink milk. The beverages are designed for consumption by individuals of all ages to provide the same nutritional value as skim milk in addition to supplemental amounts of essential vitamins, amino acids, minerals and trace nutrients in the everyday diet.

### BACKGROUND OF THE INVENTION

It is now well known that good nutrition is essential to the process of bone physiology and the maintenance of a state of health in children and adults. Poor dietary habits will prevent normal bone development in childhood and early adulthood and are directly associated with childhood obesity which can result in cardiovascular disease, diabetes, respiratory disorders and can contribute to the softening of bones and teeth as well as the acceleration of bone loss with advancing age. Milk has long been recognized as an excellent nutritional source of essential minerals such as calcium and potassium, high quality protein and vitamins such as D, A, B₂, B₁, B₆ and B₁₂.

Proper levels of these elements are essential in the diets of children, adolescents and adults for the development and maintenance of a healthy lifestyle. Such elements also assist in and promote healthy pregnancies, enhance appetite, and in the elderly, help to prevent osteoporosis, colon cancer and heart disease.

A major nutritional problem exists in North America in that the annual consumption of milk per capita is declining and is fourth to beer, soft drinks and bottled water. Consumers reject milk for taste, mouthfeel, fat content and in susceptible individuals, lactose intolerance. Recommended daily intake levels of vitamins, e.g., A, D, and the B group, as well as minerals, e.g., calcium, magnesium and potassium, cannot be supplemented by other commercial, non-dairy beverages due to unavailability. We know of no prior art that discloses any flavored, fortified, carbonated, dairy nutrient beverages that provide enhanced supplementation of the levels of essential vitamins, minerals and amino acids comparable to those available in fortified milk.

When compared to fat free milk and carbonated soft drink beverages, the following results are obtained.

| Per 8 oz. | SKIM MILK | SOFT DRINK | INVENTION |
|---|---|---|---|
| Calories (kilocalories) | 90 | 130 | 70 |
| Carbohydrates (g) | 13 | 35 | 9 |
| Fat (g) | 0 | 0 | 0 |
| Protein (g) | 8 | 0 | 9 |
| Cholesterol (mg) | ≦5 | 0 | 0 |
| Vitamin A (IU) | 500 | 0 | 500 |
| Vitamin D (IU) | 100 | 0 | 100 |
| Vitamin C (mg) | 2.5 | 0 | 20 |
| B1 (Thiamine) (mg) | 0.17 | 0 | 0.17 |
| B2 (Riboflavin) (mg) | 0.17 | 0 | 0.17 |
| B6 (Pyrodoxine) (mg) | 0.87 | 0 | 0.87 |
| B12 (Cobolamin) (mcg) | 1.34 | 0 | 1.34 |
| Folic Acid (IU) | 0 | 0 | 0.05 |
| Sodium (mg) | 122 | 25 | 115 |
| Calcium (mg) | 301 | 0 | 315 |
| Potassium (mg) | 382 | 0 | 382 |
| Phosphorus (mg) | 247 | 0 | 290 |
| Magnesium (mg) | 27 | 0 | 27 |
| Iron (mg) | 0.07 | 0 | 0.07 |
| Copper (mg) | 0.025 | 0 | 0.025 |
| Carbonation (vols) | 0 | 4.0 | 2.0 |

The chart clearly illustrates how our novel beverage provides, at a minimum, the same nutritional benefit as milk with respect to essential vitamins, minerals and other beneficial substances naturally present in, or added as fortifications to milk. Moreover, the levels of some nutritive substances, e.g., calcium, in our beverage exceed the levels found in milk. Unless expressly stated otherwise, as used herein, all liquid components are measured in gallons or fractions thereof and all solid components are measured in grams or fractions thereof.

U.S. Pat. No. 4,738,856 to Clark et al. discloses calcium, magnesium and potassium aspartate compositions as anti-hypertensive nutrition agents. Clark et al. provides that non-dairy nutritional beverages facilitate and control the transport of calcium ions into the human body while lowering blood pressure and lowering the probability or tendency of incurring colon cancer. Clark et al further discloses that beverages may provide nutritional supplementation of magnesium and/or potassium to the human diet, help reduce premenstrual tension in women, and increase cardiac tolerance in conditions of anoxia.

Clark et al. does not disclose a dairy nutrient beverage prepared from milk that will provide not only large amounts of calcium, magnesium and/or potassium to the human diet, but also supplementation of essential vitamin A, vitamin D, B complex vitamins, vitamin C, vitamin K, phosphorus, iron and strontium. Clark et al., fails to disclose carbonation of a beverage to enhance the acceptance of the taste of B complex vitamins, minerals and iron in beverage preparations, enhance the mouth-feel of dairy products to increase consumer appeal enjoyed by carbonated beverages and extend the shelf life of dairy products by suppressing the growth of bacteria.

U.S. Pat. No. 5,624,700 to Lyon et al. discloses a process to add carbon dioxide under low shear conditions to an already formed food to produce a semi-solid or solid carbonated food. Lyon et al. does not disclose the carbonation of liquid skim milk or a dry powder preparation of skim milk along with vitamins and minerals to produce an enhanced liquid dairy nutrient product for the supplementation of high levels of essential vitamins and minerals in human nutrition.

What is needed and what we have invented is an all natural, flavored, fortified, carbonated dairy nutrient beverage that provides high dietary levels of essential vitamins, minerals and amino acids that facilitates their absorption, which reduces the tendency to childhood obesity and therefore cardiovascular disease, diabetes, respiratory disorders and aids in the building of healthy bones and teeth and reduces the probability of developing osteoporosis. The inventive beverage also aids in the prevention of rickets in young people and the development of premenstrual tension (PMS) in women. Folic acid of the B-complex vitamins is supplemented by this invention to counter its deficiency in the typical human diet, which may cause megaloblastosis, weight loss, anemia, cardiac enlargement, congestive heart failure, and in pregnant women, development of a fetus with spina bifida.

The beverage supplies a rapidly and highly absorbable source of dairy calcium, magnesium and potassium to the human body without gastric upset and stomach bloating, and thus provides an ideal composition for consumption by humans who are “At Risk” of developing cardiovascular disease, diabetes, and bone diseases such as osteoporosis or osteomalacia. The beverage in an alternate formulation further supplies Vitamin E and Carotenoids such as xeazanthin, lycopene and lutein to improve cardiovascular health and eyesight in the elderly.

Another persistent problem with respect to milk-based beverages is the presence of bacteria such as coliform, an enteric variety. Pasteurization has been, until now, the standard method used to eliminate, or at least minimize the development of bacterial colonies so as to extend the useable shelf life of milk or milk-based products. Pasteurization, in its simplest form, involves the application of heat to a substance for a specified time to destroy potentially harmful microorganisms. Variations on the standard pasteurization method have been developed to further extend the shelf life of products such as milk. One such variation is known as HTST (high temperature short time) pasteurization that utilizes temperatures of from about 165° F. to about 195° F. and time periods from about 2 seconds to about 30 seconds. Exposure time is inversely proportional to the temperature used.

A second variation is VAT pasteurization that utilizes temperatures up to about 175° F. for a time period up to about 40 minutes. A yet further variation, UHT (ultra-high temperature) pasteurization, utilizes temperatures in excess of 215° F. for about 2 to about 5 seconds. UHT pasteurization is often used to extend the shelf life of chocolate flavored milk drinks from 14 days under refrigeration with standard heat pasteurization to up to 90 days under refrigeration, and is the method typically used when chocolate milk drinks are to be kept refrigerated on store shelves for over 21 days. Whether standard or UHT pasteurization is used, stabilizers and preservatives have to be added to provide a stable product. If vitamins and minerals are added to flavored milk drinks that are to be pasteurized, gel binders are also added to stabilize the flavors, colors and nutritive additions. Gel binders present additional problems. It is well known that various gel binders have a significant negative laxative effect on susceptible individuals, e.g., children and the elderly. This is a yet further reason why certain individuals forego drinking even flavored milks.

Problems with off flavors and poor mouth feel may persist when standard methods of UHT pasteurization are used, even with the use of stabilizers and preservatives. It is known that exposing milk or milk-based products to high heat may degrade certain components, such as Riboflavin and Vitamin A, may destroy Vitamin C, and may caramelize lactose (milk sugar), a disaccharide sugar. The latter effect generates off flavors. What is needed is an alternative to traditional methods of Pasteurization that extends the useful shelf life of milk-based products without causing any degradation in the product, and without needing binders, stabilizers or preservatives.

We have discovered that by exposing dairy nutrient beverages to CO₂ and Nitrogen gas treatment under controlled conditions, the growth of bacteria colonies can be suppressed, and degradation of flavors and nutrients can be reduced if HTST pasteurization is employed and the need for gel binders or stabilizers can be eliminated. In fact, depending on the amounts of CO₂ and Nitrogen gas that are added, the need for traditional pasteurization can also be eliminated without any appreciable negative impact on the suppression of bacteria.

### SUMMARY OF THE INVENTION

The beverage disclosed herein serves as a means of enhancing the attractiveness of dairy nutrient beverages as healthful alternatives to non-nutritious carbonated soft drinks (SCDs) in the marketplace as well as providing a delicious source of essential nutritional elements in the daily diet needed to improve the daily diet of children, reduce obesity, reduce the incidence of cardiovascular disease and high blood pressure in adults, promote the formation of healthy bones and teeth, reduce the incidence of osteoporosis and increase physical vigor, strength and endurance. The beverage also supplies more rapidly absorbed and higher levels of calcium, magnesium and potassium without gastric upset and stomach bloating. This invention further provides a pleasant vehicle for the consumption of the recommended daily requirements of essential nutrients by youth who are “AT RISK” of developing childhood obesity, rickets, osteomalacia and other bone diseases.

The beverage described herein has carbonation to enhance sensory appeal, improve body and mouth-feel, increase acceptability of dairy nutrient beverages and aid in the stabilization of milk proteins such as Lactalbumin and Casein. In one embodiment, the activity of milk lactose is neutralized by the partial mechanical elimination of the lactose with the remaining lactose eliminated by the addition of the enzyme lactase to reduce the remaining disaccharide to its two component monosaccharides (glucose and galactose) to eliminate the possibility of allergic responses such as lactose intolerance in susceptible individuals. Pure crystalline fruit fructose or a non-nutritive sweetener, or combinations thereof, such as sucralose, or sucralose and acesulfame K, can be added to enhance sweetness, taste and flavor.

Flavors such as chocolate fudge, chocolate, vanilla, mocha, almond, coconut, latte, butterscotch, coffee and fruit flavors such as peach, orange, raspberry, strawberry, saskatoon berry, blueberry, plains berry, prairie berry and apple as well as mixtures thereof can be added to enhance taste and acceptability.

Also disclosed is a method of making the beverage that employs, in one embodiment, the addition of CO₂ and Nitrogen gas to eliminate or effectively reduce the growth of bacterial colonies in the beverage and reduce degradation of nutrients if HTST pasteurization is used. In another embodiment, a variety of gases are used to de-aerate the beverage to enhance the stability of the underlying mixture. In a further embodiment, Nitrogen gas is added post pasteurization to enhance beverage stability and shelf life and to reduce the amount of carbon dioxide needed to prevent bacterial and/or mold growth among other benefits. These and other advantages will become apparent from a reading of the following detailed description.

### DETAILED DESCRIPTION OF THE INVENTION

The beverage composition in its broadest aspect comprises skim (fat free) milk centrifuged to separate the milk into a plasma (liquid) phase and a milk solids (solid) phase. The liquid phase, once separated, is filtered through an ultra-filtration filter having a pore size in the range of from about 0.05 to about 10 μm at a pressure of from about 0 to about 145 psi to form a first filtrate and a first retentate. The first filtrate is used in a subsequent step disclosed hereinbelow. The first retentate (primarily lactose) is reserved for further processing as a byproduct of the process. In an alternative embodiment, liquid skim milk or nonfat dry milk (skim) powder may be used. If skim powder is used, it is reconstituted to skim milk specifications with ultrafiltered tap or reverse osmosis (RO) purified water. Either alternative is centrifuged to separate it into a liquid phase and a milk solids phase.

The milk solids phase having a first volume is rinsed by mixing thoroughly at low shear into three times the first volume of reverse osmosis (RO) water carbonated to a level of about 1.5 volumes of CO₂ to form a second filtrate and a second retentate. The solid phase is mixed with the carbonated water from about 4 to about 30 minutes. The mixture is next filtered through an ultra-filtration filter having a pore size of from about 0.05 to about 10 μm at a pressure of from about 0 to about 145 psi to form a second filtrate and a second retentate. The second filtrate and the second retentate from this step are reserved for further processing.

The first filtrate is next treated with CO₂ gas in a closed container at a temperature of from about 35 to about 38° F. until the volume of gas dissolved in the filtrate reaches from about 3 to about 4 volumes. The resulting liquid/gas mixture is mixed at low shear to removed dissolved O₂ for a period of about 5 minutes. The liquid/gas mixture is next combined with the second filtrate and the second retentate while maintaining the temperature of the resulting mixture at about 90° F.

In another aspect of the disclosure, about three times the skim milk, in original liquid or reconstituted powder form, is placed in a closed vessel fitted with a HEPA filter system with 99.997% efficiency to remove any airborne particulates or bacteria larger than 0.2 microns in size. The skim milk is then chilled from about 30° F. to about 33° F. for three (3) to six (6) hours at atmospheric pressure under controlled conditions so that a percentage of the lactose sugar in the milk is crystallized (approximately 70%) with an average crystal size of from about 200 to about 250μ. The crystallized lactose is removed by mechanical separation via ultrafiltration. It should be understood that the percentage of lactose crystallized is not critical to its removal as any lactose remaining after crystallization and mechanical removal is addressed with the following chemical means.

To eliminate the remainder of the lactose in this alternative embodiment (approximately 30% of the original lactose content per volume of milk), about 3.32 ml/gal of Lactase Enzyme (Aspergillus) is added to the fluid permeate to hydrolyze the remaining Lactose, a disaccharide, into two monosaccharides—Glucose and Galactose. The permeate/Lactase mixture is incubated at about 40° F. for about 20 hours until hydrolysis is complete. After the Lactose hydrolysis step is complete, the essentially Lactose-free skim milk is heated to about 90° F. in a steam jacketed kettle or blending tank.

To add sweetness and flavor to any of the foregoing milk embodiments including the skim milk embodiment, natural and/or artificial sweeteners and/or flavors are added. For each gallon of pasteurized, lactose-free skim milk prepared in accordance with the foregoing procedure, from about 0.1 to about 10 lbs of crystalline fructose, from about 0.1 to about 10 oz. of a flavoring agent selected from the group consisting of natural and/or artificial Orange, natural and/or artificial Lemon, natural and/or artificial Strawberry, natural and/or artificial Pomegranate, natural and/or artificial Acai, natural and/or artificial Goji Berry, natural and/or artificial Cola, natural and/or artificial Saskatoon Berry, natural and/or artificial Vanilla, Vanilla extract or Vanillin, natural and/or artificial Grape, natural and/or artificial Lime, natural and/or artificial Ginger, natural and/or artificial Root Beer, natural and/or artificial Birch Beer, natural and/or artificial Sarsaparilla, natural and/or artificial Tangerine, natural and/or artificial Mango, natural and/or artificial Peach, natural and/or artificial Cherry, natural and/or artificial Apple, natural and/or artificial Banana, natural and/or artificial White, Black and/or Green Teas, natural and/or artificial Chocolate, natural and/or artificial Kiwi, natural and/or artificial Coconut, natural and/or artificial Blueberry, natural and/or artificial Raspberry, natural and/or artificial Cranberry, natural and/or artificial Guarbana and/or mixtures thereof are added.

To provide optional coloring to the beverage, coloring agents may be added to the skim milk prepared as described above. For each gallon of pasteurized, lactose-free skim milk are added from about 0.001% to about 0.9% of a natural and/or artificial Metachromatic coloring agent may be added. The coloring agent is selected from the group consisting of Red Beet Root, Aronia Fruit Anthocyanins from grapes, Elderberries, Black Carrots, Red Cabbage, Hibiscus, Purple Sweet Potatoes, Blueberries and Saskatoon Berries and/or mixtures thereof. Additional coloring agents include Anatto Extract, Beta Carotene, Beet Juice, Turmeric, FD & C Yellow 5 (Tartrazine), FD & C Yellow 6 (Sunset Yellow), FD & C Blue 1 (Brilliant Blue FCF), FD & C Blue 2 (Indigotine), FD & C Red 3 (Erythrosine), FD & C Red 40 (Allura Red) and/or mixtures thereof. To any of the milk-based formulations, from about 100 to about 400 IU of Vitamin D Palmitate (D3), may be added by mixing the vitamin into the mixture. The addition of Vitamin D may be formed before, after, or during, the addition of any of the other ingredients disclosed herein.

One benefit of the addition of colorants is as an indicator of product spoilage. If product spoilage occurs due to bacterial growth, a pH change out of the range from about 6.7 to about 4.9 will take place in the product and lead to a color change, indicative of product spoilage.

The resulting blend of the pasteurized, Lactose-free skim milk, sweetener and optional flavoring and/or coloring is well mixed at very low shear while infusing filtered CO₂ gas in a closed container to adjust the dissolved CO₂ content to about 1.5 volumes. Prior to administration of the CO₂ gas, all solid, liquid and gaseous impurities, e.g., oils, aromatic hydrocarbons, aldehydes, sulfur compounds and/or bacteria are removed from the gas. The additional CO₂ gas displaces any trapped air present in the blend prior to Pasteurization. The gas also increases the efficiency of Pasteurization by the complete removal of aerobic bacteria without the use of heat so as to preserve high heat labile nutrients (vitamins, enzymes, etc.) contained in the milk base of the blend and to avoid carmalization of the added sugar sweetener, e.g. fructose.

In an alternative aspect of the disclosure, optionally, the blend next may be passed through an HTST Pasteurizer at from about 165° to about 170° F. for about 25 seconds with no homogenization. The resulting product is collected in a sterile container and chilled to from about 32° to about 35° F.

A final mixture of CO₂ gas and Nitrogen gas is added to the mixture where the partial pressure of CO₂ gas is from about 1% to about 99% of the total gas mixture and the partial pressure of nitrogen is from about 1% to about 99%, and where the gas mixture is infused at a pressure of about 10 lb./in.². This assures final removal of any trapped air or oxygen that can support aerobic bacterial growth. After each degassing, any dissolved air rises to the top and is removed with a bleed-off valve. This procedure may be repeated for up to about five (5) minutes to assure the complete removal of trapped air.

After degassing, filtered CO₂ gas (approximately 100%) is applied to the product in a closed chamber with constant flow adjusted to about 10 lb./in.² until a volume of dissolved CO₂ of from about 1.0 to about 3.5 volumes of CO₂ gas is achieved. During the CO₂ gas infusion, the temperature of the product blend must be maintained at about 32° to about 35° F. to assure effective and uniform carbonization.

The product is then checked for the following final CO₂ gas content before bottling under aseptic conditions into any size containers including 8 oz. and 12 oz. PET bottles. The resulting product may include per 8 oz., Calcium from about 34 to about 40% RDI, protein from about 8 to about 10 g, CO₂ gas from about 1.0 to about 3.5 volumes (the higher the CO₂ content, the lower the pH), pH from about 6.5 to about 4.9 and calories at about 70.

In a further aspect of the disclosure, from about 0.1 to about 4 volumes of Nitrogen is mixed with from about 0.1 to about 4 volumes of carbon dioxide per 8 oz. of beverage solution. The final CO₂/N₂ level may be adjusted from about 1 to about 2 volumes. Alternatively, the final CO₂/N₂ level may be adjusted to about 1.5 volumes.

The addition of Nitrogen with the carbon dioxide exhibits several advantages. The nitrogen/carbon dioxide mixture provides additional protection from oxygen pick-up by the beverage. The mixture also reduces the amount of carbon dioxide needed to prevent bacterial and/or mold growth, which extends shelf life. The nitrogen component has a low solubility, less than 2%, which means it will leave the beverage when the container is opened. The carbon dioxide component has a higher solubility and remains in the beverage to provide the desired sensory benefits. Another added benefit is that the presence of nitrogen reduces the amount of carbon dioxide needed, which, in turn, lowers the acidity without affecting the extended shelf life. Additional benefits include improvement in texture, taste and appearance of the beverage as well as ice-crystal growth inhibition in low temperature beverage storage.

There are at least two ways in which the Nitrogen may be introduced into the beverage. The first is to introduce the Nitrogen in liquid form. The second is by gas sparger. Whichever option is chosen, each is added after any pasteurization step.

It is to be understood that the sequence of adding the ingredients as set forth herein is not essential to the production of the beverage mixture with one exception. It is important that the calcium salt(s) be added to the mixture before the magnesium salt(s) to prevent undesired clumping.

Having described the invention, it should be understood that the foregoing description of the invention is intended merely to be illustrative thereof and that other modifications, embodiments and equivalents may be apparent to those who are skilled in the art without departing from its spirit.

Having thus described the invention, what we claim as new and desire to secure by United States Letters Patent is:

1. A reduced calorie beverage composition suitable for human consumption comprising per gallon:
about one gallon of skim milk having stabilized protein and essentially fee of lactose, wherein about 70% of an initial lactose content is removed by ultrafiltration, and wherein about 30% of the initial lactose content not removed by ultrafiltration is hydrolyzed;
glucose and galactose derived from the hydrolysation of about 30% of the initial lactose content of the skim milk;
from about 0.1 lb. to about 10 lb. of a sweetener;
from about 0.1 oz. to about 10 oz. of a flavoring agent; and,
from about 16.0 to about 56.0 volumes of CO₂.

2. The beverage composition of claim 1 wherein the skim milk is selected from the group consisting of liquid skim milk, non-fat dry milk powder and mixtures thereof.

3. The beverage composition of claim 1 wherein the skim milk comprises non-fat dry milk powder reconstituted with water.

4. The beverage composition of claim 1 further comprising from about 0.1 to about 4.0 volumes of nitrogen.

5. The beverage composition of claim 1 further comprising:
from about 0.01 meq to about 119 meq of calcium ions supplied from about 1 mg to about 9,000 mg of a calcium salt derived from the group consisting of milk, whey and/or milk protein concentrate.

6. The beverage composition of claim 1 wherein the sweetener is crystalline fructose, acesulfame K, saccharine, aspartame, sucralose, fructose polymers, glucose, glucose polymers, invert sugar, fructose syrup, glucose syrup, corn syrup, sucrose, sugar alcohols, maple syrup, honey, fruit syrups selected from the group consisting of apple, grape, and pear and/or mixtures thereof.

7. The beverage composition of claim 1 wherein the flavoring agent is selected from the group consisting of natural and/or artificial Orange, natural and/or artificial Lemon, natural and/or artificial Strawberry, natural and/or artificial Pomegranate, natural and/or artificial Acai, natural and/or artificial Goji Berry, natural and/or artificial Cola, natural and/or artificial Saskatoon Berry, natural and/or artificial Vanilla, Vanilla extract or Vanillin, natural and/or artificial Grape, natural and/or artificial Lime, natural and/or artificial Ginger, natural and/or artificial Root Beer, natural and/or artificial Birch Beer, natural and/or artificial Sarsaparilla, natural and/or artificial Tangerine, natural and/or artificial Mango, natural and/or artificial Peach, natural and/or artificial Cherry, natural and/or artificial Apple, natural and/or artificial Banana, natural and/or artificial White, Black and/or Green Teas, natural and/or artificial Chocolate, natural and/or artificial Kiwi, natural and/or artificial Coconut, natural and/or artificial Blueberry, natural and/or artificial Raspberry, natural and/or artificial Cranberry, natural and/or artificial Guarbana, chocolate fudge, chocolate, vanilla, vanilla cappuccino, guarana, strawberry, prairie berry, mocha, latte, peach, almond, coconut, raspberry, bubblegum, cotton candy, Saskatoon berry, plains berry, apple, orange, butterscotch, coffee, blueberry, papaya, orange, cherry, tea, banana, lemon, lime, grape, watermelon cola, root beer and mixtures thereof.

8. The beverage composition of claim 1 further comprising from about 50 IU to about 600 IU of vitamin D.

9. The beverage composition of claim 1 further comprising from about 0.1 mg to about 1000 mg of vitamin C.

10. The beverage composition of claim 1 further comprising from about 200 IU to about 5000 IU of vitamin A.

11. The beverage composition of claim 1 further comprising from about 0.001 mg to about 0.40 mg of folic acid.

12. The beverage composition of claim 1 further comprising from about 50 IU to 500 IU of Vitamin E.

13. The beverage composition of claim 1 further comprising from about 0.0002 g to 0.0009 g lutein.

14. The beverage composition of claim 1 further comprising from about 0.0002 g to 0.0009 g zeaxanthin.

15. The beverage composition of claim 1 further comprising from about 50 IU to about 600 IU of vitamin D; from about 0.1 mg to about 1000 mg of vitamin C; from about 200 IU to about 5000 IU of vitamin A and from about 0.001 mg to about 0.4 mg of folic acid.

16. The beverage composition of claim 1 wherein the composition has a pH of from about 4:9 to about 6.5.

17. The beverage composition of claim 1 further comprising lactase in an amount sufficient to at least partially eliminate the activity of the milk lactose contained in the milk.

18. The beverage composition of claim 3 wherein the water is selected from the group consisting of ultra-filtered water, RO water, distilled, purified water and mixtures thereof.

19. A method of making a reduced calorie dairy nutrient beverage comprising the steps of:
providing skim milk containing stabilized milk protein and lactose;
chilling the milk to crystallize about 70% of the lactose;
filtering the milk to remove at least a portion of the crystallized lactose;
adding lactase enzyme to hydrolyze about 30% uncrystallized lactose to form glucose and galactose;
adding a sweetener to the milk to form a blend;
mixing the blend at low shear;
infusing CO₂ into the blend after crystallizing, filtering and hydrolyzing the lactose without destabilizing the milk protein;
pasteurizing the blend;
infusing a mixture of CO₂ gas and Nitrogen gas into the blend without destabilizing the protein.

20. The method of claim 19 further comprising the steps of:
separating the skim milk into a plasma phase and a milk solids phase having a first volume;
filtering the plasma phase to form a first filtrate and a first retentate;
mixing at low shear the milk solids phase with about three times the first volume of reverse osmosis water carbonated to a level of about 1.5 volumes of CO₂ to form a second filtrate and a second retentate;
treating the first filtrate with CO₂ gas at a temperature of from about 35 to about 38° F. until the volume of gas dissolved in the filtrate reaches from about 3 to about 4 volumes;
removing dissolved O₂ from the mixture of the first filtrate and the CO₂ gas; and,
combining the first filtrate/gas mixture with the second filtrate and the second retentate.
